(19) United States
(12) Patent Application Publication
(10) Pub. No.: US 2026/0253383 A1
(43) Pub. Date: Aug. 27, 2026

(54) SCENE CLASSIFICATION BASED DATA COLLECTION TRIGGER

(71) Applicant: QUALCOMM Incorporated, San Diego, CA (US)

(72) Inventors: Per CRONVALL, Linköping (SE); Gustav Nils Ture PERSSON, Ljungsbro (SE); Gustav Lars Henrik JAGBRANT, Linköping (SE)

(21) Appl. No.: 19/064,522

(22) Filed: Feb. 26, 2025

(51) Int. Cl. G06V 10/764; G01S 17/89; G06V 20/56; G06V 20/58

(52) U.S. Cl. CPC G06V 10/764; G01S 17/89; G06V 20/582; G06V 20/588

(57) ABSTRACT

Systems and techniques are described for triggering sensor data collection. For example, a computing device can obtain sensor data of a scene. The computing device can determine, using an object classifier based on the sensor data, a respective first probability an object in the scene is in each class of a plurality of classes. The computing device can determine, using a scene classifier based on the sensor data, a respective second probability of an existence of the object in each class of the plurality of classes. The computing device can determine a discrepancy between at least one of the respective first probabilities and at least one of the respective second probabilities. The computing device can trigger recording of the sensor data of the scene based on the determined discrepancy between the at least one of the respective first probabilities and the at least one of the respective second probabilities.

### FIELD

The present disclosure relates to a scene classification based data collection trigger for training and/or evaluation of object detection systems (e.g., for detecting traffic signs, buildings, vehicles, and/or other objects in a scene.

### BACKGROUND

Many devices and systems can obtain data (e.g., image frames or video), such as from their environment (e.g., including a scene). In some cases, the data can be processed for performing one or more functions, can be output for display, can be output for processing and/or consumption by other devices, among other uses.

An artificial neural network attempts to replicate, using computer technology, logical reasoning performed by the biological neural networks that constitute animal brains. Deep neural networks, such as convolutional neural networks, are widely used for numerous applications, such as object detection, object classification, object tracking, big data analysis, among others. In some examples, convolutional neural networks are able to extract high-level features, such as facial shapes, from an input image, and use these high-level features to output a probability that, for example, an input image includes a particular object.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods and computer-readable media for triggering sensor data collection. In some aspects, an apparatus for triggering sensor data collection is provided. The apparatus includes at least one memory and at least one processor coupled to the at least one memory and configured to: obtain, from one or more sensors, sensor data of a scene; determine, using an object classifier based on the sensor data, a respective first probability an object in the scene is in each class of a plurality of classes; determine, using a scene classifier based on the sensor data, a respective second probability of an existence of the object in each class of the plurality of classes; determine a discrepancy between at least one of the respective first probabilities and at least one of the respective second probabilities; and trigger recording of the sensor data of the scene based on the determined discrepancy between the at least one of the respective first probabilities and the at least one of the respective second probabilities.

In some aspects, a method for triggering sensor data collection is provided. The method includes: obtaining, by one or more sensors, sensor data of a scene; determining, by an object classifier based on the sensor data, a respective first probability an object in the scene is in each class of a plurality of classes; determining, by a scene classifier based on the sensor data, a respective second probability of an existence of the object in each class of the plurality of classes; determining a discrepancy between at least one of the respective first probabilities and at least one of the respective second probabilities; and triggering recording of the sensor data of the scene based on the determined discrepancy between the at least one of the respective first probabilities and the at least one of the respective second probabilities.

In some aspects, a non-transitory computer-readable medium having stored thereon instructions that, when executed by at least one processor, cause the at least one processor to: obtain, from one or more sensors, sensor data of a scene; determine, using an object classifier based on the sensor data, a respective first probability an object in the scene is in each class of a plurality of classes; determine, using a scene classifier based on the sensor data, a respective second probability of an existence of the object in each class of the plurality of classes; determine a discrepancy between at least one of the respective first probabilities and at least one of the respective second probabilities; and trigger recording of the sensor data of the scene based on the determined discrepancy between the at least one of the respective first probabilities and the at least one of the respective second probabilities.

In some aspects, an apparatus for triggering sensor data collection is provided. The apparatus includes: means for obtaining sensor data of a scene; means for determining, based on the sensor data, a respective first probability an object in the scene is in each class of a plurality of classes; means for determining, based on the sensor data, a respective second probability of an existence of the object in each class of the plurality of classes; means for determining a discrepancy between at least one of the respective first probabilities and at least one of the respective second probabilities; and means for triggering recording of the sensor data of the scene based on the determined discrepancy between the at least one of the respective first probabilities and the at least one of the respective second probabilities.

In some aspects, one or more of the apparatuses described herein is, can be part of, or can include a vehicle (or a computing device, system, or component of a vehicle), an extended reality device (e.g., a virtual reality (VR) device, an augmented reality (AR) device, or a mixed reality (MR) device), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIGS. 1A and 1B are block diagrams illustrating a vehicle suitable for implementing various techniques described herein, in accordance with some aspects of the disclosure.

FIG. 1C is a block diagram illustrating components of a vehicle suitable for implementing various techniques described herein, in accordance with some aspects of the disclosure.

FIG. 1D illustrates an example implementation of a system-on-a-chip (SOC), in accordance with some aspects of the disclosure.

FIG. 2 is a block diagram illustrating an example architecture of an image capture and processing system, in accordance with some aspects of the disclosure.

FIG. 3 is a block diagram illustrating an example of a deep learning network, in accordance with some aspects of the disclosure.

FIG. 4 is a block diagram illustrating an example of a convolutional neural network, in accordance with some aspects of the disclosure.

FIG. 5 is a diagram illustrating a comparison of the disclosed sensor data collection triggering system (with a scene classification based data collection trigger) to examples of existing object recognition solutions, in accordance with some aspects of the disclosure.

FIG. 6 is a diagram illustrating an example of a system for triggering sensor data collection (e.g., recording) that includes a scene classification based data collection trigger, in accordance with some aspects of the disclosure.

FIG. 7 is a diagram illustrating an example of a process for pre-processing data for training a scene classifier, in accordance with some aspects of the disclosure.

FIG. 8 is a flow diagram illustrating an example of a process for triggering sensor data collection, in accordance with some aspects of the disclosure.

FIG. 9 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As noted above, machine learning systems (e.g., deep neural network systems or models) can be used to perform a variety of tasks such as, for example and without limitation, detection and/or recognition (e.g., scene or object detection and/or recognition, face detection and/or recognition, etc.), depth estimation, pose estimation, image reconstruction, classification, three-dimensional (3D) modeling, dense regression tasks, data compression and/or decompression, and image processing, among other tasks. Moreover, machine learning models can be versatile and can achieve high quality results in a variety of tasks.

Objects in a scene can be detected and classified (e.g., recognized) using machine learning techniques, such as deep neural networks. The performance of object recognition, such as traffic sign recognition (TSR), can be critically dependent upon the quality, relevance, and diversity of the training data of the machine learning model. The validation of an object recognition system (e.g., a TSR system) can require large amounts of annotated data. Data collection and annotation (e.g., such as in autonomous driving and advanced driver-assistance systems) are expensive, and it is important that the data collected and annotated is relevant. Examples of relevant data, such as relevant traffic sign data, can include traffic signs not sufficiently represented in the training and/or validation data, traffic signs where the recognition performance is currently low, and traffic signs that have been modified and/or vandalized (e.g., traffic signs with stickers covering at least some of the text and/or symbols on the signs).

As such, improved systems and techniques for object recognition (e.g., TSR) that collect relevant data that is not sufficiently represented in the existing training data sets can be beneficial.

In one or more aspects of the present disclosure, systems, apparatuses, methods (also referred to as processes), and computer-readable media (collectively referred to herein as “systems and techniques”) are described herein that provide solutions for scene classification based data collection trigger for training and/or evaluation of object detection systems (e.g., for detecting traffic signs, road symbols, pavement markings, buildings, vehicles, and/or other objects in a scene).

Various aspects relate generally to triggering sensor data collection (e.g., recording). Some aspects more specifically relate to systems and techniques that provide solutions for optimizing data collection of objects (e.g., traffic signs) for artificial intelligence (AI) and machine learning (ML) training. The solutions provide a data-driven approach for collecting and recording data for objects (e.g., traffic signs) that are not sufficiently represented in the existing data set. For example, for traffic sign data, under-represented sign classes and signs in unusual environments may be relevant for data collection. In one or more examples, the systems and techniques can be applied for recognition of various different types of objects, including static objects (e.g., a traffic sign, a road symbol, a pavement marking, etc.) and/or mobile (e.g., dynamic) objects (e.g., a vehicle or an animal).

In one or more examples, the systems and techniques employ a scene classifier that is trained to predict the probability of one or more object classes (e.g., a first traffic sign class, a second traffic sign class, or other number of traffic sign classes, a class associated with a particular road symbol, etc.) based on information other than characteristics of the object (e.g., for traffic sign recognition, based on information other than the text or symbols on the traffic sign). The scene classifier is a machine learning model that takes as input camera (e.g., images) and potentially auxiliary sensor data (e.g., radar data and/or light detection and ranging (LIDAR) data) as input, and predicts a probability distribution over object classes (e.g., traffic sign classes). The scene classifier is trained to not consider the objects (e.g., traffic signs) themselves, but instead to analyze the scene in a holistic manner.

In some examples, the systems and techniques also employ a data collection trigger engine. The data collection trigger engine compares classes (or probability distributions over the classes) of objects detected by the object recognition (OR) system (e.g., such as a TSR system) with the probability distribution generated by the scene classifier.

In one or more aspects, during operation of a method for triggering sensor data collection (e.g., recording), one or more sensors can obtain sensor data of an object in a scene. An object classifier can determine, based on the sensor data, a respective first probability the object is in each class of a plurality of classes. A scene classifier can determine, based on the sensor data, a respective second probability of the existence of an object in each class of the plurality of classes. One or more processors (e.g., of a data collection trigger engine) can compare a highest respective first probability of the respective first probabilities to a first threshold value. The one or more processors can compare a respective second probability of the respective second probabilities to a second threshold value. In one or more examples, the respective second probability and the highest respective first probability both correspond to a same class of the plurality of classes. The one or more processors can trigger obtaining (or storing) additional sensor data of the object in the scene based on the highest respective first probability being greater than the first threshold value and the respective second probability being less than the second threshold value, or based on the highest respective first probability being less than the first threshold value and the respective second probability being greater than the second threshold value.

In one or more examples, the object classifier can be trained to determine, based on one or more characteristics of the object, the respective first probabilities the object is in each class of the plurality of classes. In some examples, the scene classifier can be trained to determine, based on one or more characteristics of the scene of the object, the respective second probabilities of the existence of an object in each class of the plurality of classes.

In some examples, one or more processors (e.g., of a pre-processor) can remove one or more portions of each image of a plurality of images, based on a plurality of respective annotations corresponding to each image of the plurality of images, to generate a plurality of training images for the scene classifier. In some examples, the scene classifier can be trained based on the plurality of training images.

In some aspects, the one or more sensors can obtain, based on the triggering, the additional sensor data. In some aspects, the one or more sensors can always obtain sensor data, and the triggering can activate the data recorder that saves the sensor data to storage or memory (e.g., a hard drive or other storage/memory in a vehicle, cloud storage, etc.). In some examples, an object detector can detect, based on the sensor data, the object within the scene. In one or more examples, the object can be a static object or a mobile object. In some examples, the static object can be a traffic sign, a road symbol, or a pavement marking. In one or more examples, the mobile object can be a vehicle or an animal. In one or more examples, at least one sensor of the one or more sensors can be an image sensor. In some examples, at least one sensor of the one or more sensors can be a radar sensor or a light detection and ranging (LIDAR) sensor. In one or more examples, the sensor data can include a plurality of images. In some examples, the sensor data can further include radar data and/or LIDAR data.

Particular aspects of the subject matter described in this disclosure can be implemented to realize one or more of the following potential advantages. For example, the systems and techniques can provide the benefit of providing an effective way to trigger collection of valuable, relevant data, which can improve the quality of data sets and, as such, improve the performance of object recognition, such as traffic sign recognition.

Additional aspects of the present disclosure are described in more detail below.

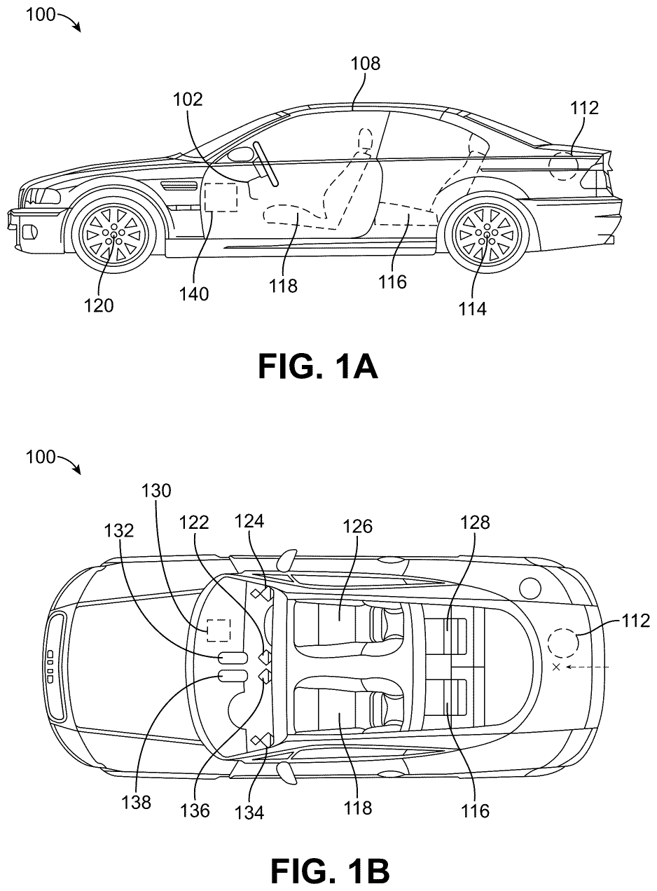

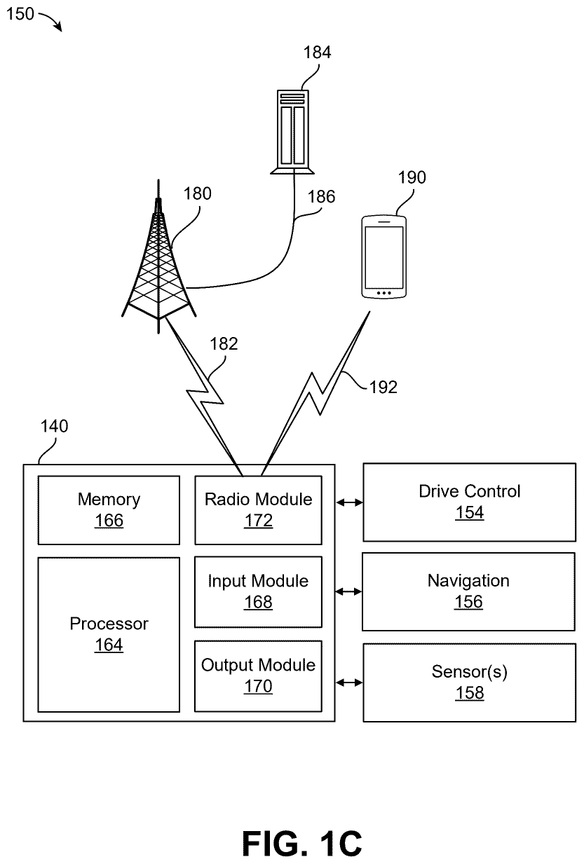

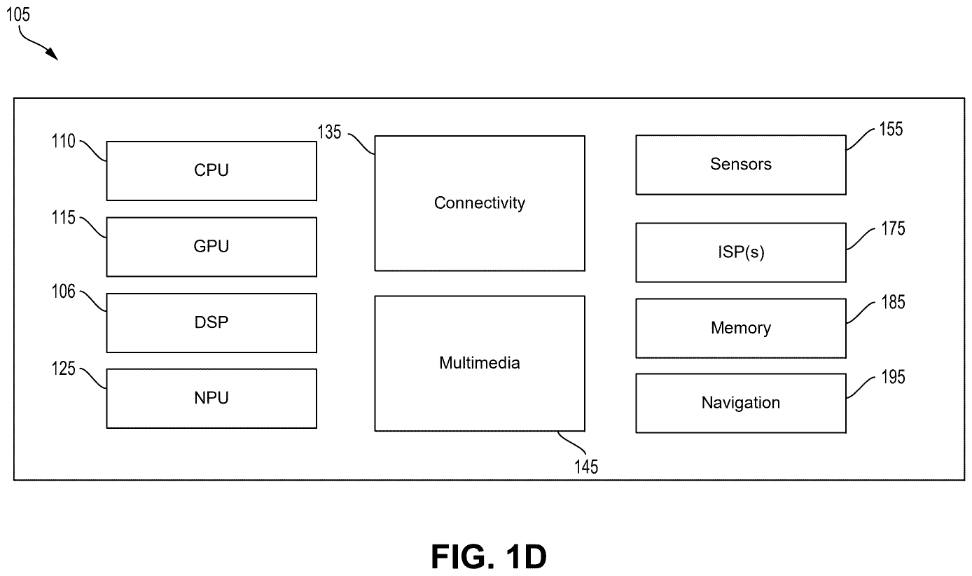

The systems and techniques described herein may be implemented by any type of system or device. One illustrative example of a system that can be used to implement the systems and techniques described herein is a vehicle (e.g., an autonomous or semi-autonomous vehicle) or a system or component (e.g., an advanced driver-assistance system (ADAS) or other system or component) of the vehicle. FIGS. 1A and 1B are diagrams illustrating an example vehicle 100 that may implement the systems and techniques described herein. With reference to FIGS. 1A and 1B, a vehicle 100 may include a control unit 140 and a plurality of sensors 102-138, including satellite geopositioning system receivers (e.g., sensors) 108, occupancy sensors 112, 116, 118, 126, 128, tire pressure sensors 114, 120, cameras 122, 136, microphones 124, 134, impact sensors 130, radar 132, and LIDAR 138. The plurality of sensors 102-138, disposed in or on the vehicle, may be used for various purposes, such as autonomous and semi-autonomous navigation and control, crash avoidance, position determination, etc., as well to provide sensor data regarding objects and people in or on the vehicle 100. The sensors 102-138 may include one or more of a wide variety of sensors capable of detecting a variety of information useful for navigation and collision avoidance. Each of the sensors 102-138 may be in wired or wireless communication with a control unit 140, as well as with each other. In particular, the sensors may include one or more cameras 122, 136 or other optical sensors or photo optic sensors. The sensors may further include other types of object detection and ranging sensors, such as radar 132, LIDAR 138, IR sensors, and ultrasonic sensors. The sensors may further include tire pressure sensors 114, 120, humidity sensors, temperature sensors, satellite geopositioning sensors 108, accelerometers, vibration sensors, gyroscopes, gravimeters, impact sensors 130, force meters, stress meters, strain sensors, fluid sensors, chemical sensors, gas content analyzers, pH sensors, radiation sensors, Geiger counters, neutron detectors, biological material sensors, microphones 124, 134, occupancy sensors 112, 116, 118, 126, 128, proximity sensors, and other sensors.

The vehicle control unit 140 may be configured with processor-executable instructions to perform various embodiments using information received from various sensors, particularly the cameras 122, 136, radar 132, and LIDAR 138. In some embodiments, the control unit 140 may supplement the processing of camera images using distance and relative position information (e.g., relative bearing angle) that may be obtained from radar 132 and/or LIDAR 138 sensors. The control unit 140 may further be configured to control steering, breaking and speed of the vehicle 100 when operating in an autonomous or semi-autonomous mode using information regarding other vehicles determined using various embodiments.

FIG. 1C is a component block diagram illustrating a system 150 of components and support systems suitable for implementing various embodiments. With reference to FIGS. 1A, 1B, and 1C, a vehicle 100 may include a control unit 140, which may include various circuits and devices used to control the operation of the vehicle 100. In the example illustrated in FIG. 1C, the control unit 140 includes a processor 164, memory 166, an input module 168, an output module 170 and a radio module 172. The control unit 140 may be coupled to and configured to control drive control components 154, navigation components 156, and one or more sensors 158 of the vehicle 100.

The control unit 140 may include a processor 164 that may be configured with processor-executable instructions to control maneuvering, navigation, and/or other operations of the vehicle 100, including operations of various embodiments. The processor 164 may be coupled to the memory 166. The control unit 140 may include the input module 168, the output module 170, and the radio module 172.

The radio module 172 may be configured for wireless communication. The radio module 172 may exchange signals 182 (e.g., command signals for controlling maneuvering, signals from navigation facilities, etc.) with a network node 180, and may provide the signals 182 to the processor 164 and/or the navigation components 156. In some embodiments, the radio module 172 may enable the vehicle 100 to communicate with a wireless communication device 190 through a wireless communication link 92. The wireless communication link 92 may be a bidirectional or unidirectional communication link and may use one or more communication protocols.

The input module 168 may receive sensor data from one or more vehicle sensors 158 as well as electronic signals from other components, including the drive control components 154 and the navigation components 156. The output module 170 may be used to communicate with or activate various components of the vehicle 100, including the drive control components 154, the navigation components 156, and the sensor(s) 158.

The control unit 140 may be coupled to the drive control components 154 to control physical elements of the vehicle 100 related to maneuvering and navigation of the vehicle, such as the engine, motors, throttles, steering elements, other control elements, braking or deceleration elements, and the like. The drive control components 154 may also include components that control other devices of the vehicle, including environmental controls (e.g., air conditioning and heating), external and/or interior lighting, interior and/or exterior informational displays (which may include a display screen or other devices to display information), safety devices (e.g., haptic devices, audible alarms, etc.), and other similar devices.

The control unit 140 may be coupled to the navigation components 156 and may receive data from the navigation components 156. The control unit 140 may be configured to use such data to determine the present position and orientation of the vehicle 100, as well as an appropriate course toward a destination. In various embodiments, the navigation components 156 may include or be coupled to a global navigation satellite system (GNSS) receiver system (e.g., one or more Global Positioning System (GPS) receivers) enabling the vehicle 100 to determine its current position using GNSS signals. Alternatively, or in addition, the navigation components 156 may include radio navigation receivers for receiving navigation beacons or other signals from radio nodes, such as Wi-Fi access points, cellular network sites, radio station, remote computing devices, other vehicles, etc. Through control of the drive control components 154, the processor 164 may control the vehicle 100 to navigate and maneuver. The processor 164 and/or the navigation components 156 may be configured to communicate with a server 184 on a network 186 (e.g., the Internet) using wireless signals 182 exchanged over a cellular data network via network node 180 to receive commands to control maneuvering, receive data useful in navigation, provide real-time position reports, and assess other data.

The control unit 140 may be coupled to one or more sensors 158. The sensor(s) 158 may include the sensors 102-138 as described, and may the configured to provide a variety of data to the processor 164.

While the control unit 140 is described as including separate components, in some embodiments some or all of the components (e.g., the processor 164, the memory 166, the input module 168, the output module 170, and the radio module 172) may be integrated in a single device or module, such as a system-on-chip (SOC) processing device. Such an SOC processing device may be configured for use in vehicles and be configured, such as with processor-executable instructions executing in the processor 164, to perform operations of various embodiments when installed into a vehicle.

FIG. 1D illustrates an example implementation of a system-on-a-chip (SOC) 105, which may include a central processing unit (CPU) 110 or a multi-core CPU, configured to perform one or more of the functions described herein. In some cases, the SOC 105 may be based on an ARM instruction set. In some cases, CPU 110 may be similar to processor 164. Parameters or variables (e.g., neural signals and synaptic weights), system parameters associated with a computational device (e.g., neural network with weights), delays, frequency bin information, task information, among other information may be stored in a memory block associated with a neural processing unit (NPU) 125, in a memory block associated with a CPU 110, in a memory block associated with a graphics processing unit (GPU) 115, in a memory block associated with a digital signal processor (DSP) 106, in a memory block 185, and/or may be distributed across multiple blocks. Instructions executed at the CPU 110 may be loaded from a program memory associated with the CPU 110 or may be loaded from a memory block 185.

The SOC 105 may also include additional processing blocks tailored to specific functions, such as a GPU 115, a DSP 106, a connectivity block 135, which may include fifth generation (5G) connectivity, fourth generation long term evolution (4G LTE) connectivity, Wi-Fi connectivity, USB connectivity, Bluetooth connectivity, and the like, and a multimedia processor 145 that may, for example, detect and recognize gestures. In one implementation, the NPU is implemented in the CPU 110, DSP 106, and/or GPU 115. The SOC 105 may also include a sensor processor 155, image signal processors (ISPs) 175, and/or navigation module 195, which may include a global positioning system. In some cases, the navigation module 195 may be similar to navigation components 156 and sensor processor 155 may accept input from, for example, one or more sensors 158. In some cases, the connectivity block 135 may be similar to the radio module 172.

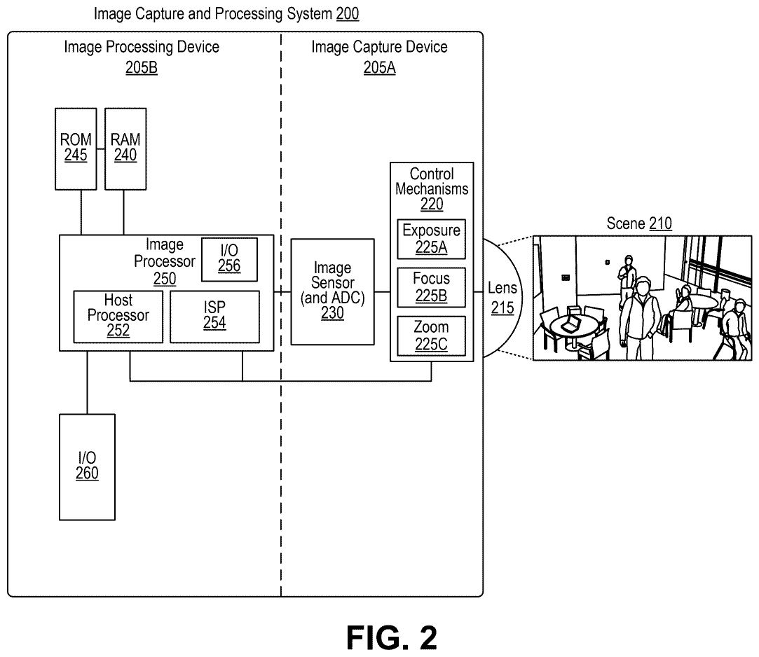

FIG. 2 is a block diagram illustrating an architecture of an image capture and processing system 200. The image capture and processing system 200 includes various components that are used to capture and process images of scenes (e.g., an image of a scene 210). The image capture and processing system 200 can capture standalone images (or photographs) and/or can capture videos that include multiple images (or video frames) in a particular sequence. A lens 215 of the system 200 faces a scene 210 and receives light from the scene 210. The lens 215 bends the light toward the image sensor 230. The light received by the lens 215 passes through an aperture controlled by one or more control mechanisms 220 and is received by an image sensor 230.

The one or more control mechanisms 220 may control exposure, focus, and/or zoom based on information from the image sensor 230 and/or based on information from the image processor 250. The one or more control mechanisms 220 may include multiple mechanisms and components; for instance, the control mechanisms 220 may include one or more exposure control mechanisms 225A, one or more focus control mechanisms 225B, and/or one or more zoom control mechanisms 225C. The one or more control mechanisms 220 may also include additional control mechanisms besides those that are illustrated, such as control mechanisms controlling analog gain, flash, HDR, depth of field, and/or other image capture properties.

The focus control mechanism 225B of the control mechanisms 220 can obtain a focus setting. In some examples, focus control mechanism 225B store the focus setting in a memory register. Based on the focus setting, the focus control mechanism 225B can adjust the position of the lens 215 relative to the position of the image sensor 230. For example, based on the focus setting, the focus control mechanism 225B can move the lens 215 closer to the image sensor 230 or farther from the image sensor 230 by actuating a motor or servo, thereby adjusting focus. In some cases, additional lenses may be included in the system 200, such as one or more microlenses over each photodiode of the image sensor 230, which each bend the light received from the lens 215 toward the corresponding photodiode before the light reaches the photodiode. The focus setting may be determined via contrast detection autofocus (CDAF), phase detection autofocus (PDAF), or some combination thereof. The focus setting may be determined using the control mechanism 220, the image sensor 230, and/or the image processor 250. The focus setting may be referred to as an image capture setting and/or an image processing setting.

The exposure control mechanism 225A of the control mechanisms 220 can obtain an exposure setting. In some cases, the exposure control mechanism 225A stores the exposure setting in a memory register. Based on this exposure setting, the exposure control mechanism 225A can control a size of the aperture (e.g., aperture size or f/stop), a duration of time for which the aperture is open (e.g., exposure time or shutter speed), a sensitivity of the image sensor 230 (e.g., ISO speed or film speed), analog gain applied by the image sensor 230, or any combination thereof. The exposure setting may be referred to as an image capture setting and/or an image processing setting.

The zoom control mechanism 225C of the control mechanisms 220 can obtain a zoom setting. In some examples, the zoom control mechanism 225C stores the zoom setting in a memory register. Based on the zoom setting, the zoom control mechanism 225C can control a focal length of an assembly of lens elements (lens assembly) that includes the lens 215 and one or more additional lenses. For example, the zoom control mechanism 225C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 215 in some cases) that receives the light from the scene 210 first, with the light then passing through an afocal zoom system between the focusing lens (e.g., lens 215) and the image sensor 230 before the light reaches the image sensor 230. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 225C moves one or more of the lenses in the afocal zoom system, such as the negative lens and one or both of the positive lenses.

The image sensor 230 includes one or more arrays of photodiodes or other photosensitive elements. Each photodiode measures an amount of light that eventually corresponds to a particular pixel in the image produced by the image sensor 230. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 230 may alternately or additionally include opaque and/or reflective masks that block light from reaching certain photodiodes, or portions of certain photodiodes, at certain times and/or from certain angles, which may be used for phase detection autofocus (PDAF). The image sensor 230 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 220 may be included instead or additionally in the image sensor 230. The image sensor 230 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 250 may include one or more processors, such as one or more image signal processors (ISPs) (including ISP 254), one or more host processors (including host processor 252), and/or one or more of any other type of processor 1810 discussed with respect to the computing system 1800. The host processor 252 can be a digital signal processor (DSP) and/or other type of processor. In some implementations, the image processor 250 is a single integrated circuit or chip (e.g., referred to as a system-on-chip or SoC) that includes the host processor 252 and the ISP 254. In some cases, the chip can also include one or more input/output ports (e.g., input/output (I/O) ports 256), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 256 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 252 can communicate with the image sensor 230 using an I2C port, and the ISP 254 can communicate with the image sensor 230 using an MIPI port.

The image processor 250 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 250 may store image frames and/or processed images in random access memory (RAM) 240/1825, read-only memory (ROM) 245/1820, a cache 1812, a memory unit (e.g., system memory 1815), another storage device 1830, or some combination thereof.

Various input/output (I/O) devices 260 may be connected to the image processor 250. The I/O devices 260 can include a display screen, a keyboard, a keypad, a touchscreen, a trackpad, a touch-sensitive surface, a printer, any other output devices 1835, any other input devices 1845, or some combination thereof. In some cases, a caption may be input into the image processing device 205B through a physical keyboard or keypad of the I/O devices 260, or through a virtual keyboard or keypad of a touchscreen of the I/O devices 260. The I/O 260 may include one or more ports, jacks, or other connectors that enable a wired connection between the system 200 and one or more peripheral devices, over which the system 200 may receive data from the one or more peripheral device and/or transmit data to the one or more peripheral devices. The I/O 260 may include one or more wireless transceivers that enable a wireless connection between the system 200 and one or more peripheral devices, over which the system 200 may receive data from the one or more peripheral device and/or transmit data to the one or more peripheral devices. The peripheral devices may include any of the previously-discussed types of I/O devices 260 and may themselves be considered I/O devices 260 once they are coupled to the ports, jacks, wireless transceivers, or other wired and/or wireless connectors.

In some cases, the image capture and processing system 200 may be a single device. In some cases, the image capture and processing system 200 may be two or more separate devices, including an image capture device 205A (e.g., a camera) and an image processing device 205B (e.g., a computing device coupled to the camera). In some implementations, the image capture device 205A and the image processing device 205B may be coupled together, for example via one or more wires, cables, or other electrical connectors, and/or wirelessly via one or more wireless transceivers. In some implementations, the image capture device 205A and the image processing device 205B may be disconnected from one another.

As shown in FIG. 2, a vertical dashed line divides the image capture and processing system 200 of FIG. 2 into two portions that represent the image capture device 205A and the image processing device 205B, respectively. The image capture device 205A includes the lens 215, control mechanisms 220, and the image sensor 230. The image processing device 205B includes the image processor 250 (including the ISP 254 and the host processor 252), the RAM 240, the ROM 245, and the I/O 260. In some cases, certain components illustrated in the image capture device 205A, such as the ISP 254 and/or the host processor 252, may be included in the image capture device 205A.

The image capture and processing system 200 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 200 can include one or more wireless transceivers for wireless communications, such as cellular network communications, 802.11 wi-fi communications, wireless local area network (WLAN) communications, or some combination thereof. In some implementations, the image capture device 205A and the image processing device 205B can be different devices. For instance, the image capture device 205A can include a camera device and the image processing device 205B can include a computing device, such as a mobile handset, a desktop computer, or other computing device.

While the image capture and processing system 200 is shown to include certain components, one of ordinary skill will appreciate that the image capture and processing system 200 can include more components than those shown in FIG. 2. The components of the image capture and processing system 200 can include software, hardware, or one or more combinations of software and hardware. For example, in some implementations, the components of the image capture and processing system 200 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 200.

The host processor 252 can configure the image sensor 230 with new parameter settings (e.g., via an external control interface such as I2C, I3C, SPI, GPIO, and/or other interface). In one illustrative example, the host processor 252 can update exposure settings used by the image sensor 230 based on internal processing results of an exposure control algorithm from past image frames. The host processor 252 can also dynamically configure the parameter settings of the internal pipelines or modules of the ISP 254 to match the settings of one or more input image frames from the image sensor 230 so that the image data is correctly processed by the ISP 254. Processing (or pipeline) blocks or modules of the ISP 254 can include modules for lens (or sensor) noise correction, de-mosaicing, color conversion, correction or enhancement/suppression of image attributes, denoising filters, sharpening filters, among others. Each module of the ISP 254 may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image sensor 230 can support dynamic switching between different operational modes that the image sensor 230 supports. Examples of the different operation modes include power off mode, software standby mode, stream on and off mode, among others. For instance, in stream operation mode, the image sensor is fully powered. With the stream operation on, the image sensor starts streaming image data (e.g., on the CSI-2 PHY layer port or interface). With the stream operation off, the image sensor stops streaming image data. In some cases, the host processor 252 can perform a dynamic parameter reconfiguration process that allows the image sensor 230 to support dynamic switching between the different operational modes without going through stream on and off and/or software standby procedures. Dynamic parameter reconfiguration refers to a process performed by the host processor 252 (e.g., an AP or other processor) to configure and update sensor internal register settings on-the-fly (e.g., as the operational modes change) without powering off the image sensor 230 and then powering on or putting the image sensor 230 into a software standby mode. Software standby mode refers to an operational mode of the image sensor 230 where the image sensor 230 is powered on and the camera control interface (CCI) communication is operational, but the image sensor 230 cannot capture and stream image data (e.g., on the CSI bus).

Such dynamic switching can reduce latency of mode switching processing and can improve user experience. Examples of the image sensor 230 dynamically switching between different operational modes include switching between turning high dynamic range (HDR) on and off, switching between a different number of exposures, switching between turning binning on and off (e.g., generating a 12 megapixel (MP) image using a 2×2 Quad Color Filter Array (QCFA) when binning is on and generating a 48 MP image by remosaicing the QCFA to a Bayer color filter array (CFA) when binning is off), among others.

Switching between operational modes (referred to as mode-switching scenarios) is different than changing image capture settings (referred to as non-mode-switching scenarios). For example, modifying image capture settings (e.g., exposure, focus, etc.) can result in a modification of how an image is captured and/or processed by the image sensor 230 and/or the ISP 254 (e.g., resulting in a brighter image, an image with a particular object in focus, etc.). However, if a setting of the image sensor 230 is incorrect or the image sensor 230 and/or ISP 254 are late in applying a setting in a non-mode-switching scenario, the result will be that a captured image is captured and/or processed with slight loss of quality in the processed image (e.g., without the intended settings, such as the image being slightly darker than intended, with an object slightly more out of focus than intended, etc.). However, when switching between operational modes in a mode-switching scenario (e.g., from HDR off to HDR on), applying the incorrect settings can result in a system failure, such as system hang or freeze, which can require a hardware reset of the ISP 254 and/or other components of the image capture and processing system 200. For instance, if the ISP 254 is unaware of the correct settings of an image frame produced by the image sensor 230 and mistakenly applies erroneous settings or parameters on that image frame for internal pipeline processing, the ISP 254 may freeze and require a hardware reset. As a result, instead of outputting an image frame with reduced quality, the image capture and processing system 200 may have to temporarily shut down and restart (e.g., the display screen may show a blank screen while the system 200 resets).

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

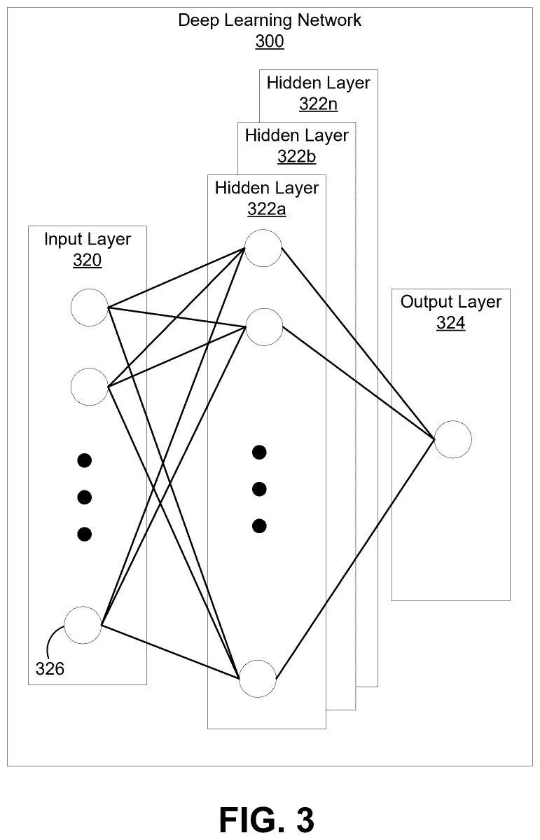

FIG. 3 is an illustrative example of a deep learning neural network 300 that can be used by the machine learning model. An input layer 320 includes input data. In some examples, the input layer 320 can include data representing the pixels of an input video frame. The neural network 300 includes multiple hidden layers 322a, 322b, through 322n. The hidden layers 322a, 322b, through 322n include “n” number of hidden layers, where “n” is an integer greater than or equal to one. The number of hidden layers can be made to include as many layers as needed for the given application. The neural network 300 further includes an output layer 324 that provides an output resulting from the processing performed by the hidden layers 322a, 322b, through 322n. In some examples, the output layer 324 can provide a classification for an object in an input video frame. The classification can include a class identifying the type of object (e.g., a person, a dog, a cat, or other object).

The neural network 300 is a multi-layer neural network of interconnected nodes. Each node can represent a piece of information. Information associated with the nodes is shared among the different layers and each layer retains information as information is processed. In some cases, the neural network 300 can include a feed-forward network, in which case there are no feedback connections where outputs of the network are fed back into itself. In some cases, the neural network 300 can include a recurrent neural network, which can have loops that allow information to be carried across nodes while reading in input.

Information can be exchanged between nodes through node-to-node interconnections between the various layers. Nodes of the input layer 320 can activate a set of nodes in the first hidden layer 322a. For example, as shown, each of the input nodes of the input layer 320 is connected to each of the nodes of the first hidden layer 322a. The nodes of the hidden layers 322a, 322b, through 322n can transform the information of each input node by applying activation functions to the information. The information derived from the transformation can then be passed to and can activate the nodes of the next hidden layer 322b, which can perform their own designated functions. Example functions include convolutional, up-sampling, data transformation, and/or any other suitable functions. The output of the hidden layer 322b can then activate nodes of the next hidden layer, and so on. The output of the last hidden layer 322n can activate one or more nodes of the output layer 324, at which an output is provided. In some cases, while nodes (e.g., node 326) in the neural network 300 are shown as having multiple output lines, a node has a single output and all lines shown as being output from a node represent the same output value.

In some cases, each node or interconnection between nodes can have a weight that is a set of parameters derived from the training of the neural network 300. Once the neural network 300 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 300 to be adaptive to inputs and able to learn as more and more data is processed.

The neural network 300 is pre-trained to process the features from the data in the input layer 320 using the different hidden layers 322a, 322b, through 322n in order to provide the output through the output layer 324. In an example in which the neural network 300 is used to identify objects in images, the neural network 300 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [0 0 1 0 0 0 0 0 0 0].

In some cases, the neural network 300 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 300 is trained well enough so that the weights of the layers are accurately tuned.

For the example of identifying objects in images, the forward pass can include passing a training image through the neural network 300. The weights are initially randomized before the neural network 300 is trained. The image can include, for example, an array of numbers representing the pixels of the image. Each number in the array can include a value from 0 to 255 describing the pixel intensity at that position in the array. In some examples, the array can include a 28×28×3 array of numbers with 28 rows and 28 columns of pixels and 3 color components (such as red, green, and blue, or luma and two chroma components, or the like).

For a first training iteration for the neural network 300, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 300 is unable to determine low level features and thus cannot make an accurate determination of what the classification of the object might be. A loss function can be used to analyze error in the output. Any suitable loss function definition can be used. An example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 300 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and η denotes a learning rate. The learning rate can be set to any suitable value, with a high learning rate including larger weight updates and a lower value indicating smaller weight updates.

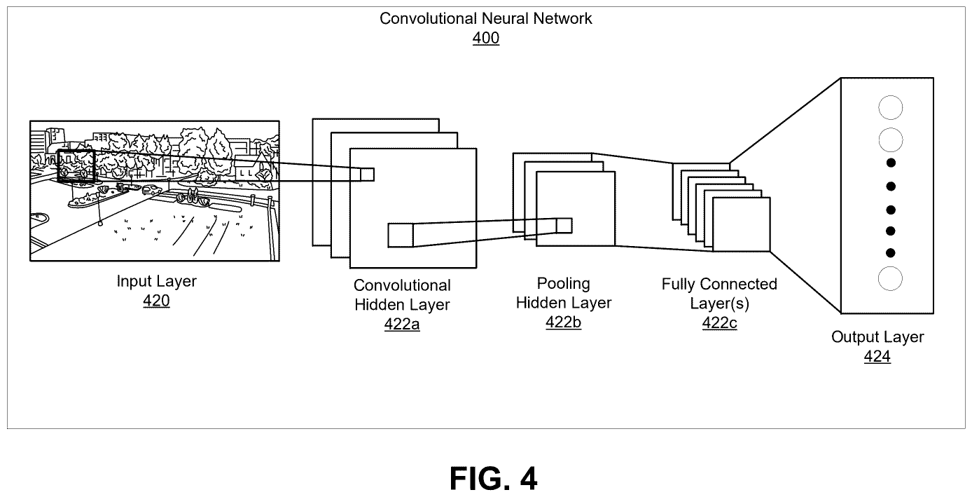

The neural network 300 can include any suitable deep network. As described previously, an example of a neural network 300 includes a convolutional neural network (CNN), which includes an input layer and an output layer, with multiple hidden layers between the input and out layers. An example of a CNN is described below with respect to FIG. 4. The hidden layers of a CNN include a series of convolutional, nonlinear, pooling (for downsampling), and fully connected layers. The neural network 300 can include any other deep network other than a CNN, such as an autoencoder, a deep belief nets (DBNs), a Recurrent Neural Networks (RNNs), among others.

FIG. 4 is an illustrative example of a convolutional neural network 400 (CNN 400). The input layer 420 of the CNN 400 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 422a, an optional non-linear activation layer, a pooling hidden layer 422b, and fully connected hidden layers 422c to get an output at the output layer 424. While only one of each hidden layer is shown in FIG. 4, one of ordinary skill will appreciate that multiple convolutional hidden layers, non-linear layers, pooling hidden layers, and/or fully connected layers can be included in the CNN 400. As previously described, the output can indicate a single class of an object or can include a probability of classes that best describe the object in the image.

The first layer of the CNN 400 is the convolutional hidden layer 422a. The convolutional hidden layer 422a analyzes the image data of the input layer 420. Each node of the convolutional hidden layer 422a is connected to a region of nodes (pixels) of the input image called a receptive field. The convolutional hidden layer 422a can be considered as one or more filters (each filter corresponding to a different activation or feature map), with each convolutional iteration of a filter being a node or neuron of the convolutional hidden layer 422a. For example, the region of the input image that a filter covers at each convolutional iteration would be the receptive field for the filter. In some examples, if the input image includes a 28×28 array, and each filter (and corresponding receptive field) is a 5×5 array, then there will be 24×24 nodes in the convolutional hidden layer 422a. Each connection between a node and a receptive field for that node learns a weight and, in some cases, an overall bias such that each node learns to analyze its particular local receptive field in the input image. Each node of the hidden layer 422a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 422a is due to each node of the convolutional layer being applied to its corresponding receptive field. For example, a filter of the convolutional hidden layer 422a can begin in the top-left corner of the input image array and can convolve around the input image. As noted above, each convolutional iteration of the filter can be considered a node or neuron of the convolutional hidden layer 422a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 422a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 422a.

The mapping from the input layer to the convolutional hidden layer 422a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 422a can include several activation maps in order to identify multiple features in an image. The example shown in FIG. 4 includes three activation maps. Using three activation maps, the convolutional hidden layer 422a can detect three different kinds of features, with each feature being detectable across the entire image.

In some examples, a non-linear hidden layer can be applied after the convolutional hidden layer 422a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 400 without affecting the receptive fields of the convolutional hidden layer 422a.

The pooling hidden layer 422b can be applied after the convolutional hidden layer 422a (and after the non-linear hidden layer when used). The pooling hidden layer 422b is used to simplify the information in the output from the convolutional hidden layer 422a. For example, the pooling hidden layer 422b can take each activation map output from the convolutional hidden layer 422a and generates a condensed activation map (or feature map) using a pooling function. Max-pooling is an example of a function performed by a pooling hidden layer. Other forms of pooling functions be used by the pooling hidden layer 422a, such as average pooling, L2-norm pooling, or other suitable pooling functions. A pooling function (e.g., a max-pooling filter, an L2-norm filter, or other suitable pooling filter) is applied to each activation map included in the convolutional hidden layer 422a. In the example shown in FIG. 4, three pooling filters are used for the three activation maps in the convolutional hidden layer 422a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 422a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 422a having a dimension of 24×24 nodes, the output from the pooling hidden layer 422b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 400.

The final layer of connections in the network is a fully-connected layer that connects every node from the pooling hidden layer 422b to every one of the output nodes in the output layer 424. Using the example above, the input layer includes 28×28 nodes encoding the pixel intensities of the input image, the convolutional hidden layer 422a includes 3×24×24 hidden feature nodes based on application of a 5×5 local receptive field (for the filters) to three activation maps, and the pooling layer 422b includes a layer of 3×12×12 hidden feature nodes based on application of max-pooling filter to 2×2 regions across each of the three feature maps. Extending this example, the output layer 424 can include ten output nodes. In such an example, every node of the 3×12×12 pooling hidden layer 422b is connected to every node of the output layer 424.

The fully connected layer 422c can obtain the output of the previous pooling layer 422b (which should represent the activation maps of high-level features) and determines the features that most correlate to a particular class. For example, the fully connected layer 422c layer can determine the high-level features that most strongly correlate to a particular class, and can include weights (nodes) for the high-level features. A product can be computed between the weights of the fully connected layer 422c and the pooling hidden layer 422b to obtain probabilities for the different classes. For example, if the CNN 400 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 424 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In some examples, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

As previously mentioned, objects may be detected and classified (e.g., recognized) using machine learning techniques (e.g., using deep neural networks). The performance of object recognition (e.g., traffic sign recognition (TSR)) can be critically dependent upon the quality, relevance, and diversity of the training data for the machine learning model. The validation of an object recognition system, such as a TSR system, can require large amounts of annotated data. Data collection and annotation, such as in autonomous driving and advanced driver-assistance systems, are expensive. It is important that the data collected and annotated is relevant. Some examples of relevant data (e.g., relevant traffic sign data) can include, but are not limited to, traffic signs not sufficiently represented in the training and/or validation data, traffic signs where the recognition performance is currently low, and traffic signs that have been modified and/or vandalized (e.g., traffic signs with stickers covering at least some of the text and/or symbols). Therefore, improved systems and techniques for object recognition (e.g., TSR) that collects relevant data that is not sufficiently represented in the existing training data sets can be useful.

In one or more aspects, the systems and techniques provide solutions for scene classification based object (e.g., traffic sign) collection trigger. In one or more examples, the systems and techniques provide solutions for optimizing data collection of objects (e.g., traffic signs) for AI/ML training. In some examples, the solutions provide a data-driven approach for collecting and recording data for objects (e.g., traffic signs) that are not sufficiently represented in the existing data set. In one or more examples, for traffic sign data, under-represented sign classes and signs in unusual environments can be relevant for data collection. In one or more examples, the systems and techniques can be applied for recognition of various different types of objects, including static objects (e.g., a traffic sign, a road symbol, or a pavement marking) and/or mobile (e.g., dynamic) objects (e.g., a vehicle or an animal), such as where the existence is closely correlated with the appearance of the environment. The disclosure includes examples of recognition of objects in the form of traffic signs. However, the systems and techniques should not be limited in scope to these examples.

In one or more aspects, the systems and techniques employ a scene classifier that is trained to predict the probability (e.g., on a scale from zero to one) of one or more object classes (e.g., a first traffic sign class, a second traffic sign class, or other number of traffic sign classes, a class associated with a particular road symbol, etc.) based on information (e.g., such as scene information) other than the characteristic information of the object itself (e.g., such as the text and/or symbols on the traffic sign itself). For example, the speed limit for a traffic sign (e.g., object) may be approximated based on the type of road, the appearance of the road, and/or the surrounding scene of the traffic sign. For another example, the class (e.g., a stop sign) of a traffic sign may be determined based on the shape of the traffic sign (e.g., a stop sign is in the shape of an octagon) and pavement markings (e.g., a stop sign is mounted next to a stop line on the road).

The scene classifier is a machine learning model trained on images (and/or other sensor data, such as radar data and/or LIDAR data) where the object (e.g., traffic sign) of interest is not visible. In one or more examples, when the object is a traffic sign, the training images may include the images recorded right after a traffic sign has been passed, and/or sensor data where the traffic sign or traffic sign elements have been masked out.

In one or more examples, if the predicted class of an object (e.g., a traffic sign) detected by the object recognition (e.g., traffic sign recognition) system has a low probability, according to the scene classifier, a data collection event is triggered. A low probability determined by (and output from) the scene classifier indicates that the model (of the scene classifier) determines that the object (e.g., traffic sign) does not belong in the scene, or that the scene is unusual for the detected object class (e.g., traffic sign class).

In one or more examples, when a data collection event is triggered, one or more sensors (e.g., cameras, such as image sensors, radar sensors, and/or LIDAR sensors) may be commanded to obtain additional sensor data (e.g., images, radar data, and/or LIDAR data) of the object in the scene (e.g., including the environment of the object). The additional sensor data can then be stored or recorded. In some cases, the additional sensor data can be stored or recorded in response to the trigger. In some examples, the one or more sensors may be included in one or more vehicles (e.g., a fleet of vehicles) and/or in one or more computing devices.

In some rarer cases, it can also be useful to trigger data collection when the scene classifier is certain (e.g., outputs a high probability, such as a probability of 0.9 on a probability scale from zero to one) of a specific class for the object and an object recognition system (e.g., a traffic sign recognition system) is uncertain (e.g., outputs a low probability, such as a probability of 0.1 on a probability scale from zero to one) of the specific class or generates no detection of the object itself.

In one or more examples, for an incorrect classification of an object (e.g., detecting a ninety (90) kilometers per hour (km/h) traffic sign on a small gravel road) triggering obtaining additional data of the object in the scene can be useful for extending the existing training data set. In some examples, if the classification is correct, it can also be useful to trigger obtaining additional data of the object in the scene (e.g., such as for the development of autonomous driving systems for recognizing a scenario where it is not suitable to strictly follow the posted speed limit for the road). Other examples of an incorrect classification can include detecting a maximum headroom sign where there is no overhead obstacle present, and a moose warning sign in an urban city with heavy traffic. In one or more examples, if there is an adversarial attack where someone has modified (e.g., vandalized) a stop sign such that it is not able to be detected by the traffic sign recognition system, the scene classifier may be able to detect the stop sign based on the sign shape (e.g., octagon), stop line on the pavement, and a crossing road being present.

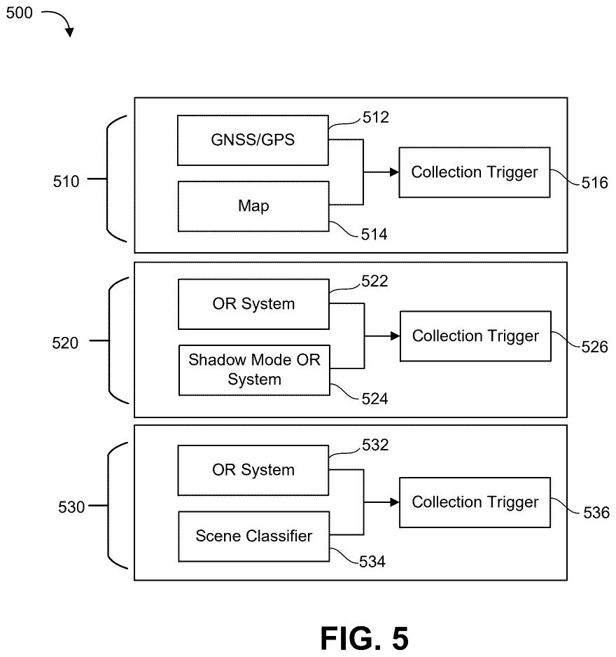

FIG. 5 shows a comparison of sensor data collection performed using the disclosed systems and techniques described herein to existing solutions. In particular, FIG. 5 is a diagram illustrating a comparison 500 of the disclosed object recognition system (with a scene classification based object collection trigger) to examples of existing object recognition solutions. FIG. 5 shows an existing map-based solution 510, an existing shadow mode solution 520, and the disclosed object recognition (OR) system (with a scene classification based object collection trigger) 530.

The existing map-based solution 510 can trigger a recording when the vehicle is at a certain location where it is known from map data that an object of interest is likely present. Conversely, the existing shadow mode solution 520 compares a probability of an object class determined by the OR system 522 (e.g., TSR system) to a probability of the object class determined by a shadow mode OR system 524 (e.g., an older version of the OR system or an alternative system to the OR system running in a shadow mode) to determine whether to command a collection trigger 526.

Converse to the existing map-based solution 510 and the existing shadow mode solution 520, the disclosed object recognition OR system (with a scene classification based object collection trigger) 530 compares a probability of an object class determined by the OR system 532 (e.g., TSR system) to a probability of the object class determined by a scene classifier 534 to determine whether to command a collection trigger 536. In one or more examples, each sign detection from the TSR system is evaluated using the probability estimate of the corresponding class from the scene classifier.

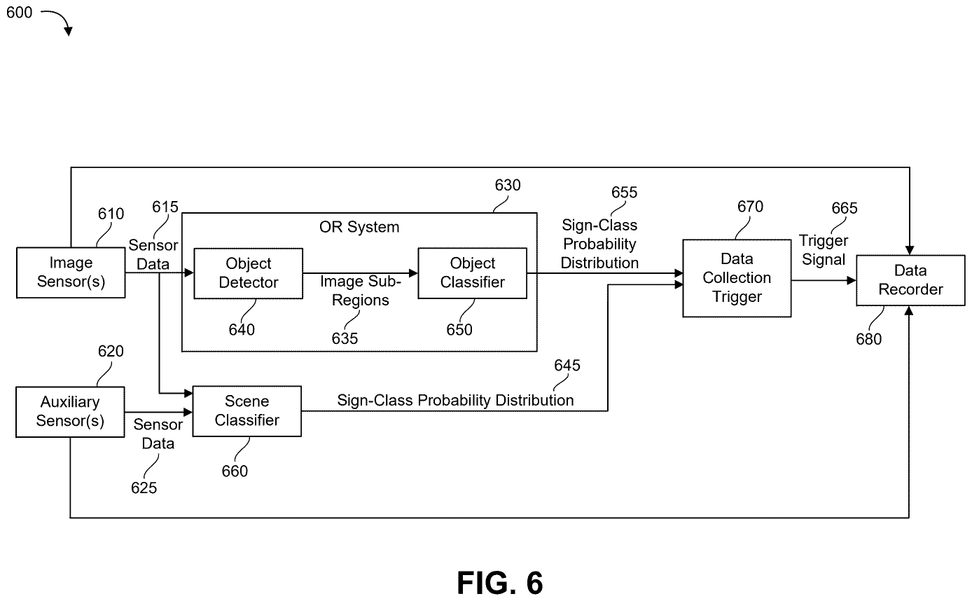

FIG. 6 shows an example of a system 600 for triggering sensor data collection (e.g., recording) including a scene classification based object collection trigger. In FIG. 6, the system 600 is shown to include one or more image sensors 610 (e.g., a camera), one or more auxiliary sensors 620 (e.g., radar sensors and/or LIDAR sensors), an OR system 630 (e.g., a TSR system), a scene classifier 660, a data collection trigger engine 670, and a data recorder 680 that can record the sensor data 615 from the one or more image sensors 610 (e.g., images from the one or more image sensors 610) and/or the sensor data 625 from the one or more auxiliary sensors 620 (e.g., radar sensor data, LIDAR sensor data, etc.). The OR system 630 is shown to include an object detector 640 (e.g., a traffic sign detector) and an object classifier 650 (e.g., a traffic sign classifier).

During operation of the system 600 of FIG. 6, the one or more image sensors 610 (e.g., camera) can obtain sensor data 615 (e.g., images) of an object (e.g., a traffic sign) in a scene. The sensor data 615 (e.g., images) can be input into the OR system 630. The object detector 640 of the OR system 630 can determine, based on the sensor data 615, image sub-regions 635 corresponding to locations of the detected object (e.g., traffic sign) within the sensor data 615 (e.g., the images). The object classifier 650 of the OR system 630 can determine, based on the image sub-regions 635 (e.g., which are based on the sensor data 615), a respective first probability 655 the object is in each class of a plurality of classes. In one or more examples, when the object is a traffic sign, the plurality of classes may include, but is not limited to, a stop sign class, a speed limit sign class, a yield sign class, and/or a railroad crossing sign class. In one or more examples, the object classifier 650 can be trained to determine, based on one or more characteristics (e.g., text and/or symbols on a traffic sign) of the object, the respective first probabilities 655 the object is in each class of the plurality of classes.

The one or more auxiliary sensors 620 can obtain sensor data 625 (e.g., radar data and/or LIDAR data) of the object (e.g., the traffic sign) in the scene. The sensor data 615 (e.g., images) as well as the sensor data 625 (e.g., radar data and/or LIDAR data) can be input into the scene classifier 660. The scene classifier 660 is a machine learning model that takes images and potentially auxiliary sensor data (e.g., LIDAR or radar data) as input, and predicts a probability distribution over object classes (e.g., traffic sign classes). The scene classifier 660 is trained to not consider the objects (e.g., traffic signs) themselves, but instead analyze the scene in a holistic manner. The scene classifier 660 can determine, based on the sensor data 615 (e.g., and also sensor data 625), a respective second probability 645 of the existence of an object in each class of the plurality of classes. In one or more examples, the scene classifier 660 can be trained to determine, based on one or more characteristics (e.g., a shape of the traffic sign and/or pavement markings near the traffic sign) of the scene or the object, the respective second probabilities 645 of the existence of an object in each class of the plurality of classes.

The respective first probabilities 655 and the respective second probabilities 645 can be input into the data collection trigger engine 670. In one or more examples, the data collection trigger engine 670 compares classes (or probability distributions over classes) of objects (e.g., traffic signs) detected by the OR system 630 (e.g., the TSR system) with the probability distribution generated by the scene classifier 660.

One or more processors (e.g., of a data collection trigger engine 670) can compare a highest respective first probability of the respective first probabilities (e.g., p_{TSR}(cᵢ), for any detection i, where cᵢ=argmaxⱼp_{TSR,i}(cⱼ) to a first threshold value (e.g., τ_{TSR} or θ_{TSR}). The one or more processors (e.g., of the data collection trigger engine 670) can compare a respective second probability of the respective second probabilities (e.g., p_{scene}(cᵢ)) to a second threshold value (e.g., τ_{scene} or θ_{scene}). In one or more examples, the respective second probability and the highest respective first probability both correspond to a same class (e.g., a stop sign class) of the plurality of classes (e.g., a stop sign class, a speed limit sign class, a yield sign class, and a railroad crossing sign class).

The one or more processors (e.g., of the data collection trigger engine 670) can trigger the recording of sensor data (e.g., such as images, LIDAR data, and/or radar data) of the scene (including the object in the scene) based on the highest respective first probability being greater than the first threshold value (e.g., p_{TSR}(cᵢ)>τ_{TSR}, for any detection i, where cᵢ=argmaxⱼp_{TSR,i}(cⱼ) and the respective second probability being less than the second threshold value (e.g., p_{scene}(cᵢ)<τ_{scene}), or based on the highest respective first probability being less than the first threshold value (e.g., p_{TSR}(c)<θ_{TSR}, for any relevant class c) and the respective second probability being greater than the second threshold value (e.g., p_{scene}(c)>θ_{scene}).

In one or more examples, the one or more processors (e.g., of the data collection trigger engine 670) can trigger the recording of sensor data by sending a trigger signal 665 to the data recorder 680 to record the sensor data 615 from the one or more image sensors 610 (e.g., images from the one or more image sensors 610) and/or the sensor data 625 from the one or more auxiliary sensors 620 (e.g., radar sensor data, LIDAR sensor data, etc.). For example, the one or more images sensors 610 and/or the one or more auxiliary sensors 620 (e.g., LIDAR sensors and/or radar sensors) can output the additional sensor data (e.g., sensor data 615 and/or sensor data 625) and, based on the triggering, the data recorder 680 can record the data from the one or more image sensors 610 and/or the one or more auxiliary sensors 620.

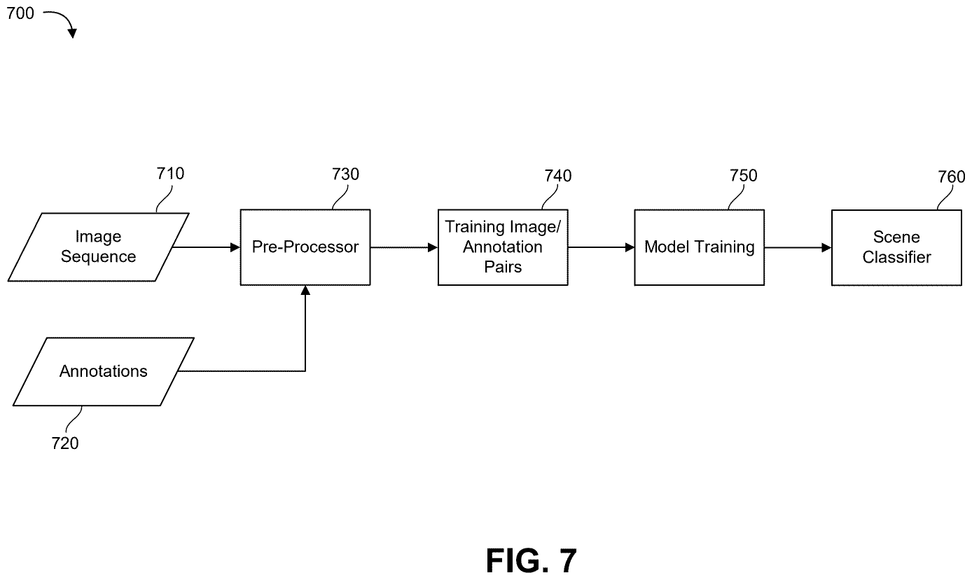

FIG. 7 shows an example process for pre-processing data for scene classifier training. In particular, FIG. 7 is a diagram illustrating an example of a process 700 for pre-processing data for training a scene classifier 760 (e.g., the scene classifier 660 of the system 600 of FIG. 6). A pre-processor 730 can be employed to prepare the data for scene classifier training. In one or more examples, annotations 720 (e.g., traffic sign annotations) can be used to mask out, remove by inpainting techniques, blur, and/or replace objects (e.g., traffic signs) or parts of objects (e.g., traffic signs) in the training images. In some examples, images may be paired with labels of objects (e.g., traffic signs) that have just been passed by the sensor (e.g., that have just left the sensor field of view).

During operation of the process 700, an image sequence 710 (e.g., including a plurality of images including objects, such as traffic signs) and corresponding annotations 720 can be input into the pre-processor 730. One or more processors (e.g., of the pre-processor 730) can remove one or more portions of each image of the plurality of images of the image sequency 710, based on a plurality of respective annotations 720 corresponding to each image of the plurality of images in the image sequence 710, to generate a plurality of training images (e.g., including training image/annotation pairs 740) for the scene classifier 760. In some examples, the scene classifier can be trained (e.g., during model training 750) based on the plurality of training images (e.g., including training image/annotation pairs 740).

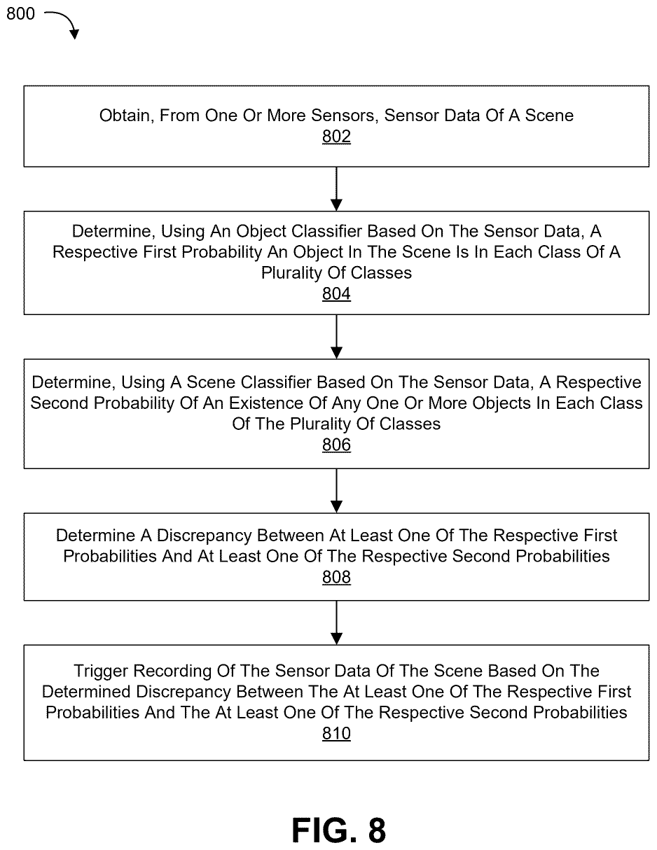

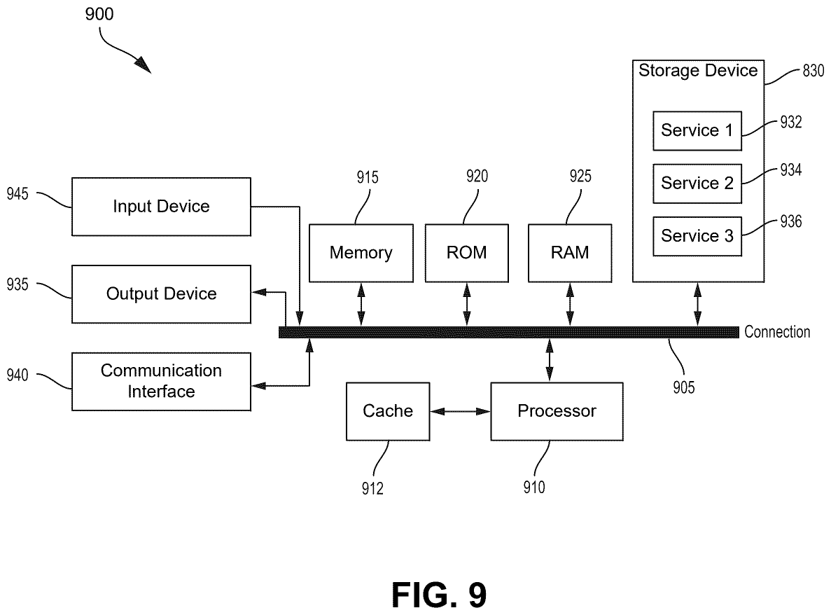

FIG. 8 is a flow chart illustrating an example of a process 800 for a scene classification based object (e.g., traffic sign) collection trigger. The process 800 can be performed by a computing device (e.g., a computing device or computing system 900 of FIG. 9) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the process 800 may be implemented as software components that are executed and run on one or more processors (e.g., processor 910 of FIG. 9, or other processor(s)). Further, the transmission and reception of signals by the computing device in the process 800 may be enabled, for example, by one or more antennas and/or one or more transceivers (e.g., wireless transceiver(s)).

At block 802, the computing device (or component thereof) can obtain, from one or more sensors, sensor data of a scene. In some examples, the object is a traffic sign, a road symbol, a pavement marking, a vehicle, an animal, or other static or moving object. In some cases, the computing device can include the one or more sensors or can receive the sensor data from the one or more sensors. In some aspects, at least one sensor of the one or more sensors is an image sensor (e.g., an image sensor of the image sensor(s) 610 of FIG. 6), a radar sensor (e.g., a radar sensor of the auxiliary sensor(s) 620 of FIG. 6), a light detection and ranging (LIDAR) sensor (e.g., a LIDAR sensor of the auxiliary sensor(s) 620 of FIG. 6), and/or other type of sensor. In some cases, the sensor data includes a plurality of images (e.g., captured by an image sensor such as a camera). In some aspects, the sensor data includes radar data (e.g., captured by a radar sensor) and/or LIDAR data (e.g., captured by a LIDAR sensor).

At block 804, the computing device (or component thereof) can determine, using an object classifier (e.g., object classifier 650 of FIG. 6) based on the sensor data, a respective first probability (e.g., sign-class probability distribution 655) an object in the scene is in each class of a plurality of classes. In some aspects, the object classifier is trained to determine, based on one or more characteristics of the object, the respective first probabilities the object in the scene is in each class of the plurality of classes.

At block 806, the computing device (or component thereof) can determine, using a scene classifier (e.g., scene classifier 660 of FIG. 6) based on the sensor data, a respective second probability (e.g., sign-class probability distribution 645) of an existence of the object in each class of the plurality of classes. In some aspects, the scene classifier is trained to determine, based on one or more characteristics of the scene of the object, the respective second probabilities of the existence of the object in each class of the plurality of classes. In some cases, one or more portions of each image of a plurality of images are removed (e.g., based on a plurality of respective annotations corresponding to each image of the plurality of images) to generate a plurality of training images for the scene classifier. In some examples, the scene classifier is trained based on the plurality of training images.

At block 808, the computing device (or component thereof) can determine a discrepancy between at least one of the respective first probabilities and at least one of the respective second probabilities.

At block 810, the computing device (or component thereof) can trigger recording (e.g., by data recorder 680 of FIG. 6) of the sensor data of the scene based on the determined discrepancy between the at least one of the respective first probabilities and the at least one of the respective second probabilities.

In some aspects, the computing device (or component thereof) can compare a highest respective first probability of the respective first probabilities to a first threshold value. The computing device (or component thereof) can also compare a respective second probability of the respective second probabilities to a second threshold value, where the respective second probability and the highest respective first probability both correspond to a same class of the plurality of classes. In some cases, to determine the discrepancy between the at least one of the respective first probabilities and the at least one of the respective second probabilities, the computing device (or component thereof) can determine the highest respective first probability is greater than the first threshold value and the respective second probability is less than the second threshold value. In such cases, the recording of the sensor data is triggered based on the highest respective first probability being greater than the first threshold value and the respective second probability being less than the second threshold value. In some cases, to determine the discrepancy between the at least one of the respective first probabilities and the at least one of the respective second probabilities, the computing device (or component thereof) can determine the highest respective first probability is less than the first threshold value and the respective second probability is greater than the second threshold value. In such cases, the recording of the sensor data is triggered based on the highest respective first probability being less than the first threshold value and the respective second probability being greater than the second threshold value.

In some cases, the computing device of process 800 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 800 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 800 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 800 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a block diagram illustrating an example of a computing system 900, which may be employed for a scene classification based object (e.g., traffic sign) collection trigger. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that communicatively couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900.

Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 940 may also include one or more range sensors (e.g., LiDAR sensors, laser range finders, RF radars, ultrasonic sensors, and infrared (IR) sensors) configured to collect data and provide measurements to processor 910, whereby processor 910 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:
Aspect 1. An apparatus for triggering sensor data collection, the apparatus comprising: at least one memory; and at least one processor coupled to the at least one memory and configured to: obtain, from one or more sensors, sensor data of a scene; determine, using an object classifier based on the sensor data, a respective first probability an object in the scene is in each class of a plurality of classes; determine, using a scene classifier based on the sensor data, a respective second probability of an existence of the object in each class of the plurality of classes; determine a discrepancy between at least one of the respective first probabilities and at least one of the respective second probabilities; and trigger recording of the sensor data of the scene based on the determined discrepancy between the at least one of the respective first probabilities and the at least one of the respective second probabilities.
Aspect 2. The apparatus of Aspect 1, wherein the at least one processor is configured to: compare a highest respective first probability of the respective first probabilities to a first threshold value; and compare a respective second probability of the respective second probabilities to a second threshold value, wherein the respective second probability and the highest respective first probability both correspond to a same class of the plurality of classes.
Aspect 3. The apparatus of Aspect 2, wherein, to determine the discrepancy between the at least one of the respective first probabilities and the at least one of the respective second probabilities, the at least one processor is configured to: determine the highest respective first probability is greater than the first threshold value and the respective second probability is less than the second threshold value, wherein the recording of the sensor data is triggered based on the highest respective first probability being greater than the first threshold value and the respective second probability being less than the second threshold value.
Aspect 4. The apparatus of Aspect 2, wherein, to determine the discrepancy between the at least one of the respective first probabilities and the at least one of the respective second probabilities, the at least one processor is configured to: determine the highest respective first probability is less than the first threshold value and the respective second probability is greater than the second threshold value, wherein the recording of the sensor data is triggered based on the highest respective first probability being less than the first threshold value and the respective second probability being greater than the second threshold value.
Aspect 5. The apparatus of any of Aspects 1 to 4, wherein the object classifier is trained to determine, based on one or more characteristics of the object, the respective first probabilities the object in the scene is in each class of the plurality of classes.
Aspect 6. The apparatus of any of Aspects 1 to 5, wherein the scene classifier is trained to determine, based on one or more characteristics of the scene of the object, the respective second probabilities of the existence of the object in each class of the plurality of classes.
Aspect 7. The apparatus of any of Aspects 1 to 6, wherein one or more portions of each image of a plurality of images are removed, based on a plurality of respective annotations corresponding to each image of the plurality of images, to generate a plurality of training images for the scene classifier.
Aspect 8. The apparatus of Aspect 7, wherein the scene classifier is trained based on the plurality of training images.
Aspect 9. The apparatus of any of Aspects 1 to 8, wherein the object is a traffic sign, a road symbol, a pavement marking, a vehicle, or an animal.
Aspect 10. The apparatus of any of Aspects 1 to 9, wherein at least one sensor of the one or more sensors is an image sensor.
Aspect 11. The apparatus of Aspect 10, wherein at least one sensor of the one or more sensors is a radar sensor or a light detection and ranging (LIDAR) sensor.
Aspect 12. The apparatus of any of Aspects 1 to 11, wherein the sensor data comprises a plurality of images.
Aspect 13. The apparatus of Aspect 12, wherein the sensor data further comprises at least one of radar data or light detection and ranging (LIDAR) data.
Aspect 14. A method for triggering sensor data collection, the method comprising: obtaining, by one or more sensors, sensor data of a scene; determining, by an object classifier based on the sensor data, a respective first probability an object in the scene is in each class of a plurality of classes; determining, by a scene classifier based on the sensor data, a respective second probability of an existence of the object in each class of the plurality of classes; determining a discrepancy between at least one of the respective first probabilities and at least one of the respective second probabilities; and triggering recording of the sensor data of the scene based on the determined discrepancy between the at least one of the respective first probabilities and the at least one of the respective second probabilities.
Aspect 15. The method of Aspect 14, further comprising: comparing a highest respective first probability of the respective first probabilities to a first threshold value; and comparing a respective second probability of the respective second probabilities to a second threshold value, wherein the respective second probability and the highest respective first probability both correspond to a same class of the plurality of classes.
Aspect 16. The method of Aspect 15, wherein determining the discrepancy between the at least one of the respective first probabilities and the at least one of the respective second probabilities comprises: determining the highest respective first probability is greater than the first threshold value and the respective second probability is less than the second threshold value, wherein the recording of the sensor data is triggered based on the highest respective first probability being greater than the first threshold value and the respective second probability being less than the second threshold value.
Aspect 17. The method of Aspect 15, wherein determining the discrepancy between the at least one of the respective first probabilities and the at least one of the respective second probabilities comprises: determining the highest respective first probability is less than the first threshold value and the respective second probability is greater than the second threshold value, wherein the recording of the sensor data is triggered based on the highest respective first probability being less than the first threshold value and the respective second probability being greater than the second threshold value.
Aspect 18. The method of any of Aspects 14 to 17, wherein the object classifier is trained to determine, based on one or more characteristics of the object, the respective first probabilities the object in the scene is in each class of the plurality of classes.
Aspect 19. The method of any of Aspects 14 to 18, wherein the scene classifier is trained to determine, based on one or more characteristics of the scene of the object, the respective second probabilities of the existence of the object in each class of the plurality of classes.
Aspect 20. The method of any of Aspects 14 to 19, further comprising removing one or more portions of each image of a plurality of images, based on a plurality of respective annotations corresponding to each image of the plurality of images, to generate a plurality of training images for the scene classifier.
Aspect 21. The method of Aspect 20, further comprising training, based on the plurality of training images, the scene classifier.
Aspect 22. The method of any of Aspects 14 to 21, wherein the object is a traffic sign, a road symbol, a pavement marking, a vehicle, or an animal.
Aspect 23. The method of any of Aspects 14 to 22, wherein at least one sensor of the one or more sensors is an image sensor.
Aspect 24. The method of Aspect 23, wherein at least one sensor of the one or more sensors is a radar sensor or a light detection and ranging (LIDAR) sensor.
Aspect 25. The method of any of Aspects 14 to 24, wherein the sensor data comprises a plurality of images.
Aspect 26. The method of Aspect 25, wherein the sensor data further comprises at least one of radar data or light detection and ranging (LIDAR) data.
Aspect 27. A non-transitory computer-readable medium having stored thereon instructions that, when executed by at least one processor, cause the at least one processor to perform operations according to any of Aspects 14 to 26.
Aspect 28. An apparatus for triggering sensor data collection, the apparatus including one or more means for performing operations according to any of Aspects 14 to 26.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for triggering sensor data collection, the apparatus comprising:
at least one memory; and
at least one processor coupled to the at least one memory and configured to:
obtain, from one or more sensors, sensor data of a scene;
determine, using an object classifier based on the sensor data, a respective first probability an object in the scene is in each class of a plurality of classes;
determine, using a scene classifier based on the sensor data, a respective second probability of an existence of any one or more objects in each class of the plurality of classes;
determine a discrepancy between at least one of the respective first probabilities and at least one of the respective second probabilities; and
trigger recording of the sensor data of the scene based on the determined discrepancy between the at least one of the respective first probabilities and the at least one of the respective second probabilities.

2. The apparatus of claim 1, wherein the at least one processor is configured to:
compare a highest respective first probability of the respective first probabilities to a first threshold value; and
compare a respective second probability of the respective second probabilities to a second threshold value, wherein the respective second probability and the highest respective first probability both correspond to a same class of the plurality of classes.

3. The apparatus of claim 2, wherein, to determine the discrepancy between the at least one of the respective first probabilities and the at least one of the respective second probabilities, the at least one processor is configured to:
determine the highest respective first probability is greater than the first threshold value and the respective second probability is less than the second threshold value, wherein the recording of the sensor data is triggered based on the highest respective first probability being greater than the first threshold value and the respective second probability being less than the second threshold value.

4. The apparatus of claim 2, wherein, to determine the discrepancy between the at least one of the respective first probabilities and the at least one of the respective second probabilities, the at least one processor is configured to:
determine the highest respective first probability is less than the first threshold value and the respective second probability is greater than the second threshold value, wherein the recording of the sensor data is triggered based on the highest respective first probability being less than the first threshold value and the respective second probability being greater than the second threshold value.

5. The apparatus of claim 1, wherein the object classifier is trained to determine, based on one or more characteristics of the object, the respective first probabilities the object in the scene is in each class of the plurality of classes.

6. The apparatus of claim 1, wherein the scene classifier is trained to determine, based on one or more characteristics of the scene of the object, the respective second probabilities of the existence of the any one or more objects in each class of the plurality of classes.

7. The apparatus of claim 1, wherein one or more portions of each image of a plurality of images are removed, based on a plurality of respective annotations corresponding to each image of the plurality of images, to generate a plurality of training images for the scene classifier.

8. The apparatus of claim 7, wherein the scene classifier is trained based on the plurality of training images.

9. The apparatus of claim 1, wherein the object is a traffic sign, a road symbol, a pavement marking, a vehicle, or an animal.

10. The apparatus of claim 1, wherein at least one sensor of the one or more sensors is an image sensor.

11. The apparatus of claim 10, wherein at least one sensor of the one or more sensors is a radar sensor or a light detection and ranging (LIDAR) sensor.

12. The apparatus of claim 1, wherein the sensor data comprises a plurality of images.

13. The apparatus of claim 12, wherein the sensor data further comprises at least one of radar data or light detection and ranging (LIDAR) data.

14. A method for triggering sensor data collection, the method comprising:
obtaining, by one or more sensors, sensor data of a scene;
determining, by an object classifier based on the sensor data, a respective first probability an object in the scene is in each class of a plurality of classes;
determining, by a scene classifier based on the sensor data, a respective second probability of an existence of the object in each class of the plurality of classes;
determining a discrepancy between at least one of the respective first probabilities and at least one of the respective second probabilities; and
triggering recording of the sensor data of the scene based on the determined discrepancy between the at least one of the respective first probabilities and the at least one of the respective second probabilities.

15. The method of claim 14, further comprising:
comparing a highest respective first probability of the respective first probabilities to a first threshold value; and
comparing a respective second probability of the respective second probabilities to a second threshold value, wherein the respective second probability and the highest respective first probability both correspond to a same class of the plurality of classes.

16. The method of claim 15, wherein determining the discrepancy between the at least one of the respective first probabilities and the at least one of the respective second probabilities comprises:
determining the highest respective first probability is greater than the first threshold value and the respective second probability is less than the second threshold value, wherein the recording of the sensor data is triggered based on the highest respective first probability being greater than the first threshold value and the respective second probability being less than the second threshold value.

17. The method of claim 15, wherein determining the discrepancy between the at least one of the respective first probabilities and the at least one of the respective second probabilities comprises:
determining the highest respective first probability is less than the first threshold value and the respective second probability is greater than the second threshold value, wherein the recording of the sensor data is triggered based on the highest respective first probability being less than the first threshold value and the respective second probability being greater than the second threshold value.

18. The method of claim 14, wherein the object classifier is trained to determine, based on one or more characteristics of the object, the respective first probabilities the object in the scene is in each class of the plurality of classes.

19. The method of claim 14, wherein the scene classifier is trained to determine, based on one or more characteristics of the scene of the object, the respective second probabilities of the existence of the object in each class of the plurality of classes.

20. The method of claim 14, further comprising removing one or more portions of each image of a plurality of images, based on a plurality of respective annotations corresponding to each image of the plurality of images, to generate a plurality of training images for the scene classifier.
